(19) United States
(12) Patent Application Publication
(10) Pub. No.: US 2004/0205049 A1
(43) Pub. Date: Oct. 14, 2004

(54) Methods and apparatus for user-centered web crawling

(75) Inventor: Charu C. Aggarwal, Ossining, NY (US)

Correspondence Address: Ryan, Mason & Lewis, LLP, 90 Forest Avenue, Locust Valley, NY, 11560, US

(73) Assignee: International Business Machines Corporation, Armonk, NY

(21) Appl. No.: 10/410,846

(22) Filed: Apr. 10, 2003

(51) Int. Cl. G06F 17/30

(52) U.S. Cl. 707/3

(57) ABSTRACT

Techniques are provided for user-centered search and crawling on an information network such as the world wide web. The techniques identify the nature of the web pages which are most relevant to a given predicate. The behavior of users is used to identify and determine the web pages which are most relevant to a specific crawl. Thus, the techniques are implemented in a web crawling system which can obtain the web pages specific to a given topic by leveraging the nature of the interests of the users in different topics.

### FIELD OF THE INVENTION

The present invention generally relates to large scale resource discovery and, more particularly, to methods and apparatus for performing collection of web pages from the world wide web utilizing user-centered web search and crawling techniques.

### BACKGROUND OF THE INVENTION

With the rapid growth of the world wide web (or “web”), the problem of resource collection on the world wide web has become very relevant in the past few years. Users often wish to search or index collections of documents based on topical or keyword queries. Consequently, a number of search engine technologies such as Yahoo!™, Lycos™ and AltaVista™ have flourished in recent years. The standard method for searching and querying on such engines has been to collect a large aggregate collection of documents and then provide methods for querying them. Such a strategy runs into problems of scale, since there are over a billion documents on the web and the web continues to grow at a pace of about a million documents a day. This results in problems of scalability both in terms of storage and performance.

Consequently, several new resource discovery techniques have been proposed in recent years. One proposed resource discovery technique is referred to as a “fish search,” as described in R. De Bra et al., “Searching for Arbitrary Information in the WWW: the Fish-Search for Mosaic,” WWW Conference, 1994, the disclosure of which is incorporated by reference herein.

Another proposed resource discovery technique is referred to as “focused crawling,” as described in S. Chakrabarti et al., “Focused Crawling: A New Approach to Topic-Specific Web Resource Discovery,” Computer Networks, 31:1623-1640, 1999; and S. Chakrabarti et al., “Distributed Hypertext Resource Discovery Through Examples,” VLDB Conference, pp. 375-386, 1999, the disclosures of which are incorporated by reference herein. The focused crawling technique enables the crawling of particular topical portions of the world wide web quickly without having to explore all web pages. The fundamental idea behind focused crawling is that there is a short range topical locality on the web. This locality may be used in order to design effective techniques for resource discovery by starting at a few well chosen points and maintaining the crawler within the ranges of these known topics. As is known, a “crawler” is a software program that can perform large scale collection of web pages from the world wide web by fetching web pages in a structured fashion. A crawler functions by first starting at a given web page; transferring the web page from a remote server using, for example, HTTP (HyperText Transfer Protocol); then analyzing the links inside the file and transferring those documents recursively.

In addition, “hubs” and “authorities” for different web pages, as described in J. Kleinberg, “Authoritative Sources in a Hyperlinked Environment,” SODA, 1998, the disclosure of which is incorporated by reference herein, may be identified and used for the purpose of crawling. The idea in such a framework is that resources on a given topic may occur in the form of hub pages (i.e., web pages containing links to a large number of pages on the same topic) or authorities (i.e., documents whose content corresponds to a given topic). Typically, the hubs on a given topic link to the authorities and vice-versa. The focused crawling approach uses the hub-authority model in addition to focusing techniques in order to perform the crawl effectively. Some recent crawler work which uses similar concepts to those mentioned above to improve the efficiency of the crawl include M. Diligenti et al., “Focused Crawling Using Context Graphs,” VLDB Conference, 2000; and S. Mukherjea, “WTMS: A System for Collecting and Analyzing Topic-Specific Web Information,” WWW Conference, 2000, the disclosures of which are incorporated by reference herein.

In order to achieve the goal of finding resources of a given topic efficiently, the focused crawling technique starts at a set of representative pages on a given topic and forces the crawler to stay focused on this topic while gathering web pages. In focused crawling, a specific linkage structure of the world wide web is assumed in which pages on a specific topic are likely to link to the same topic. Even though there is evidence that the documents on the world wide web show topical locality for many broad topical areas, conventional web crawling techniques do not have a clear understanding of how this may translate to arbitrary predicates. In addition, the focused crawling technique does not use a large amount of information which is readily available, such as the exact content of inlinking web pages, or the tokens in a given candidate URL (Uniform Resource Locator).

Thus, there is a need for resource discovery techniques that are able to effectively take user interests into consideration during the crawling process.

### SUMMARY OF THE INVENTION

The present invention realizes that, given the fact that there is a large amount of information available on an information network, such as the world wide web, which can be used for topical resource discovery, the most effective crawls can be performed only when the user interests are substantially taken into account. This is because the final judgment on the quality of the crawl is made by the users themselves. The user interests can significantly indicate the topical areas which are in the scope of his understanding. The present invention realizes that it is useful to harness this user information into the data mining process in order to find the documents, such as web pages, which are of greatest interest to users.

Thus, the present invention provides techniques for effectively taking user interests into account during the crawling process. Such user-centered network search and crawling techniques find documents on a particular topic by crawling in a carefully selective way, in which those documents which are preferred by particular users are selected out. It is to be understood that the term “document” is intended to generally refer to any data resource on the information network that may be accessed. In the context of the world wide web, a document may be a web page. However, the invention is not intended to be so limited.

Accordingly, in one aspect of the invention, a computer-based, user-centered technique for performing document retrieval in accordance with an information network comprises the following steps. First, a query comprising at least a user-defined predicate is obtained. Next, a group of one or more users is determined for a set of one or more documents that satisfy the predicate. The user group comprises one or more users who have previously accessed at least one of the one or more documents in the set. The determination of whether a user has previously accessed a document is obtained from a log that maintains data representing user document access behavior. Next, a topical inclination value is determined for each user in the user group. The topical inclination value for each user is indicative of a level of interest the user has in the one or more documents in the set. A topical affinity value is then determined for each document accessed by the user group based on the topical inclination value determined for each user. The topical affinity value for each document is indicative of the likelihood that each document satisfies the predicate based on the access behavior associated with the one or more users in the user group. Lastly, the one or more documents ranked in accordance with their respective topical affinity values are output as a response to the query.

The log data may comprise data representing user access frequency of documents previously accessed and/or data representing a topical distribution of documents previously accessed. The log data is preferably obtained in accordance with traces on the user document access behavior obtained in accordance with a proxy server.

Further, determination of the topical inclination value for a user may comprise utilizing a predicate satisfaction percentage of the one or more documents accessed by a user to determine a level of inclination of that user to topics associated with the one or more documents. The topical inclination value for each user may also be defined by an access frequency of the one or more documents belonging to the predicate compared to all other documents. Still further, time spent by a user on a document may be used to determine the topical inclination value for the user. In any case, the topical inclination values of users accessing a document may be averaged to determine the topical affinity value of the document.

Advantageously, in an illustrative embodiment for resource discovery, the present invention provides techniques for user-centered search and crawling on the world wide web. Techniques are provided for identifying the nature of the web pages which are most relevant to a given predicate. The behavior of users is used to identify and determine the web pages which are most relevant to a specific crawl. Thus, the techniques are implemented in a web crawling system which can obtain the web pages specific to a given topic by leveraging the nature of the interests of the users in different topics.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating a hardware implementation suitable for employing user-centered web crawling methodologies according to an embodiment of the present invention;

FIG. 2 is a flow diagram illustrating a user-centered web crawling methodology according to an embodiment of the present invention;

FIG. 3 is a flow diagram illustrating a process used to determine a user interest group from web pages which have been crawled according to an embodiment of the present invention;

FIG. 4 is a flow diagram illustrating a process for determining a topical inclination for each user according to an embodiment of the present invention; and

FIG. 5 is a flow diagram illustrating a process for calculating a topical affinity for each web page using a topical inclination for each user according to an embodiment of the present invention.

### DETAILED DESCRIPTION OF PREFERRED EMBODIMENTS

The following description will illustrate the resource discovery techniques of the invention in the context of the world wide web. It should be understood, however, that the invention is not necessarily limited to use with any particular network. The invention is instead more generally applicable to resource discovery in which it is desirable to improve the results of the resource discovery by effectively taking into account user interests during the network crawling process.

Before describing the techniques of the present invention, mention is made here of a proposed alternative to focused crawling, referred to as “intelligent crawling,” which is described in the commonly assigned U.S. patent application identified as Ser. No. 09/703,174 (attorney docket no. YOR920000430US1), filed on Oct. 31, 2000 and entitled “Methods and Apparatus for Intelligent Crawling on the World Wide Web;” and C. C. Aggarwal et al. “Intelligent Crawling on the WWW with Arbitrary Predicates,” WWW Conference, 2001, the disclosures of which are incorporated by reference herein.

In intelligent crawling, no specific model for a web linkage structure is assumed. Rather, the intelligent crawler gradually learns the linkage structure statistically as the crawler progresses. This technique has advantages over the focused crawling model in that it is able to use a greater amount of information available to the crawling process. Since each (candidate) web page can be characterized by a large number of features, such as the content of the inlinking pages, the tokens in a given candidate URL, the predicate satisfaction of the inlinking web pages, and sibling predicate satisfaction, it may be useful to learn how these features for a given candidate are connected to the probability that the candidate would satisfy the predicate. In general, the exact nature of this dependence is expected to be predicate-specific; thus, even though for a given predicate the documents may show topical locality, this may not be true for other predicates. For some predicates, the tokens in the candidate URLs may be more indicative of the exact behavior, whereas for others the content of the inlinking pages may provide more valuable evidence. There is no way of knowing the importance of the different features for a given predicate a-priori. It is assumed that an intelligent crawler would learn this during the crawl and find the most relevant pages.

While the intelligent crawler is quite an effective system in practice, it does not necessarily utilize the user interests very effectively.

As will be illustratively explained below, the present invention provides a web crawling model which assumes that a large number of users are accessing the world wide web with the use of a proxy server. The access behavior of the users is captured with the use of a trace at the proxy server. It is assumed that this trace contains information about the identity of the users and the web pages that they have accessed. Typically, the users who access a given topic are more likely to access documents belonging to the same topic in the near future.

As input to a crawling system of the invention, for a given resource discovery task, a user supplies a predicate, which is denoted herein by CP. An example of a predicate could be a keyword in a web document, or a topical predicate. For example, a user may be searching for all web pages which contain a particular word such as “shopping” or “PCs.” In addition, the user also supplies a number of web pages which serve as the starting points for the crawling system. The crawling system determines which users are most likely to access the web pages belonging to the predicate CP. The level of likelihood that a user is likely to access a web page which belongs to a particular predicate is referred to as “topical inclination.” Web pages which are frequently accessed by users who have a high topical inclination are likely to be ones which are most directly relevant to the predicate.

In order to find the web pages which have a very high topical relevance or affinity, the crawling technique starts off with a few example web pages in a candidate list L. This candidate list eventually contains all the URL names which need to be crawled. The candidate list is ordered on the basis of the topical affinity of these candidate pages.

The overall methodology for finding the documents of relevance is an iterative process. In this iterative process, the candidate list L is used to keep track of all the web pages which have been crawled so far. The methodology accesses the first element on this candidate list L and transfers it on the world wide web using HTTP. Then, the methodology checks whether or not the web page satisfies the user-defined predicate and, if so, the web page is added to a final set of crawled web pages F. Since all these web pages F are relevant to the predicate, it is also useful to determine all those users that have accessed these web pages. This is referred to as the user interest group U. The methodology determines all those web pages that have been accessed by the set of users U, and adds them to the list L, if they are not already in list L. Once the user interest group has been determined, the methodology finds the topical inclination of each of these users. A detailed description of the topical inclination calculation will be described below.

Next, the topical affinity of each web page in the candidate list L is calculated using the topical inclination of the users that have accessed these web pages. This value is used to rank the importance of the different web pages from the point of view of their probability of predicate satisfaction. The list is re-ordered using this criteria and the iterative process continues. The process of accessing the different URLs will be described below in greater detail.

Given a general overview of the crawling methodology of the invention, illustrative details of the inventive user-centered crawling techniques will now be provided in the context of the figures.

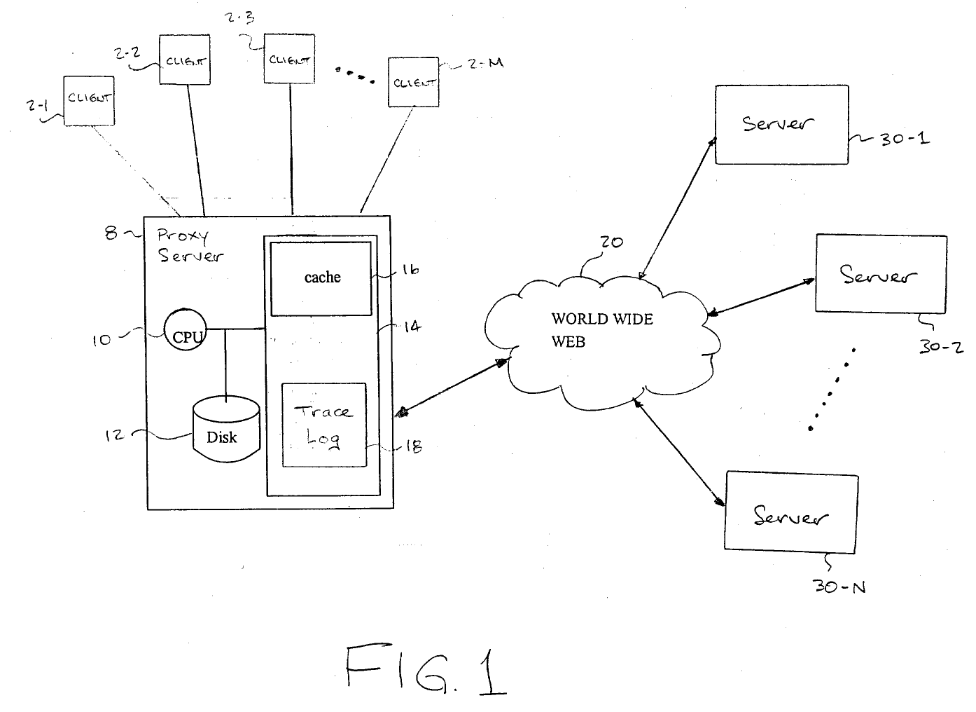

FIG. 1 is a block diagram illustrating a hardware implementation suitable for employing user-centered web crawling methodologies according to an embodiment of the present invention. As illustrated, an exemplary system includes a plurality of client device computer systems 2-1 through 2-M coupled to a large network 20 (e.g., world wide web) via a proxy server 8. The proxy server 8 is coupled, via the large network 20, to a plurality of server computer systems 30-1 through 30-N. It is to be understood that the plurality of servers 30-1 through 30-N comprise the information sources that the clients may seek to explore during his/her resource discovery tasks. While the client devices are shown coupled directly to the proxy server, it is to be understood that the client devices may be coupled to the proxy server 8 via the large network 20.

As shown, the proxy system computer system 8 may comprise a central processing unit (CPU) 10, coupled to a disk 12, and a main memory 14. Also, while not expressly shown, the system 8 may include input devices (e.g., keyboard, mouse) and output devices (e.g., display monitor, printer) for respectively entering data and viewing data associated with the methodologies described herein. The main memory 14 may also comprise a cache 16 to speed up calculations. It is assumed that proxy server computer system 8 can interact with one or more of the servers 30-1, . . . , 30-N over the large network 20. It is to be appreciated that the network 20 may be a public information network such as, for example, the Internet or world wide web, however, the client and servers may alternatively be connected via a private network, a local area network, or some other suitable network.

The behavior of the clients in terms of world wide web accesses is tracked and maintained by the proxy server 8 with the use of a trace log 18. The trace log 18 may be stored in the main memory 14 of the proxy server 8. The trace log is used to determine the preferences of the users in terms of the web access behavior of the users, and to analyze the effects of such user behavior. The trace analysis and web crawling techniques of the invention are preferably performed by the proxy server 8. Such methodologies operate under control of the CPU 10 and in conjunction with the disk 12 and main memory 14. It is to be appreciated that, in accordance with this illustrative embodiment, the disk 12 may hold the database of web pages which have been obtained off the world wide web. The CPU 10 performs the computations necessary to make decisions on the web pages which should be downloaded off the world wide web. In addition, the main memory 14 preferably caches documents and intermediate results. Details of these and other operations will be described below.

In one preferred embodiment, software components including instructions or code for performing the user-centered crawling methodologies of the invention, as described herein, may be stored in one or more memory devices described above with respect to the computer system 8 and, when ready to be utilized, loaded in part or in whole and executed by the CPU 10. Thus, the user-centered crawling methodologies of the invention may preferably be implemented as software instructions or code which executes on a computer system (i.e., under control of the CPU and in accordance with the memory and input/output components). Of course, it is to be understood that the user-centered crawler may be implemented in software, hardware and/or combinations thereof. Also, the computer system may be any processing device capable of executing the methodologies described herein, e.g., personal computer, mini-computer, micro-computer, etc. Likewise, the client devices 2-1 through 2-M and the servers 30-1 through 30-N, shown in FIG. 1, may have similar processing capabilities.

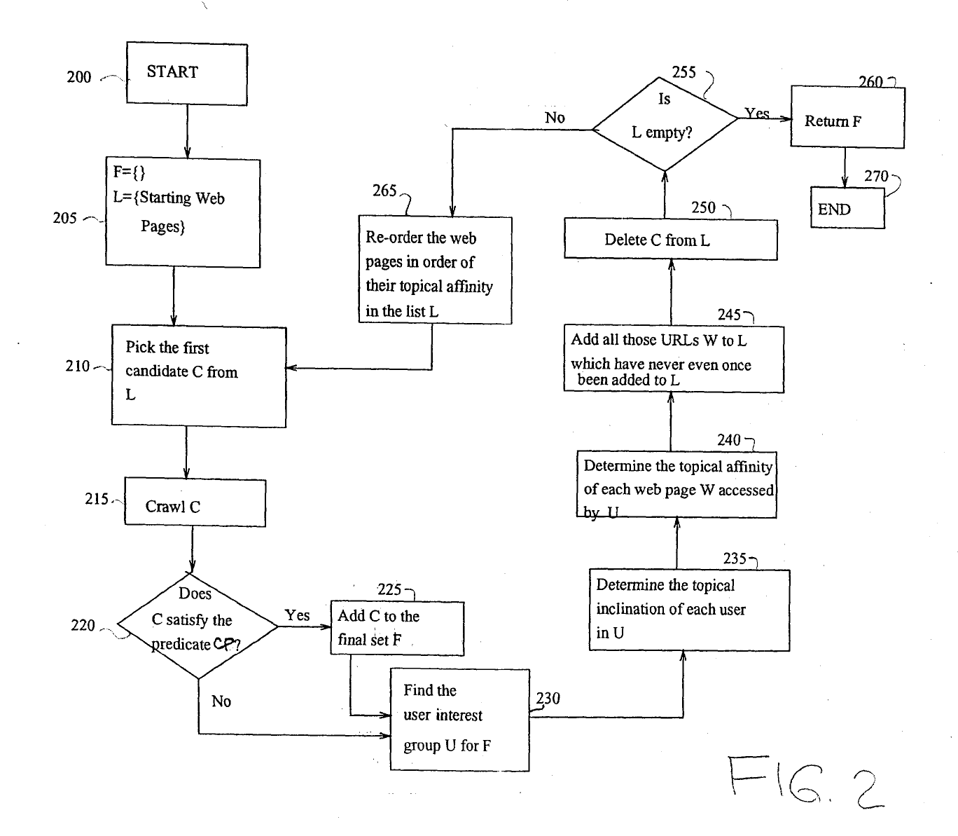

Referring now to FIG. 2, a flow diagram illustrates an overview of a user-centered web crawling methodology according to an embodiment of the present invention. The inputs to the user-centered crawling methodology include: the user trace (trace log 18) which contains the record of the web page accesses by the different users (clients 2-1 through 2-M); a starting list of web pages; and a user-defined predicate CP. The starting list and the predicate are provided by the particular client initiating the current resource discovery task.

The process uses a list L, which is used to track the set of candidate web pages. This list L contains the URLs for the web pages which will be crawled. The overall process begins at block 200. In step 205, the list L is initialized to the set of starting web pages provided as input by the user. This starting list may typically be a list of very general portal sites (such as the URL known for accessing a portal site such as Yahoo!™) which have very wide accessibility across the world wide web. In addition, a final set F of URLs crawled is initialize to null.

In step 210, the process picks the first candidate C from the list L. In step 215, the process crawls the web page C. The process of crawling a web page refers to the accessing of this web page from the corresponding world wide web site. In step 220, the process tests whether or not the candidate web page satisfies the user-defined predicate CP. If the candidate web page does satisfy the predicate, then the candidate web page is added to the final set F, in step 225.

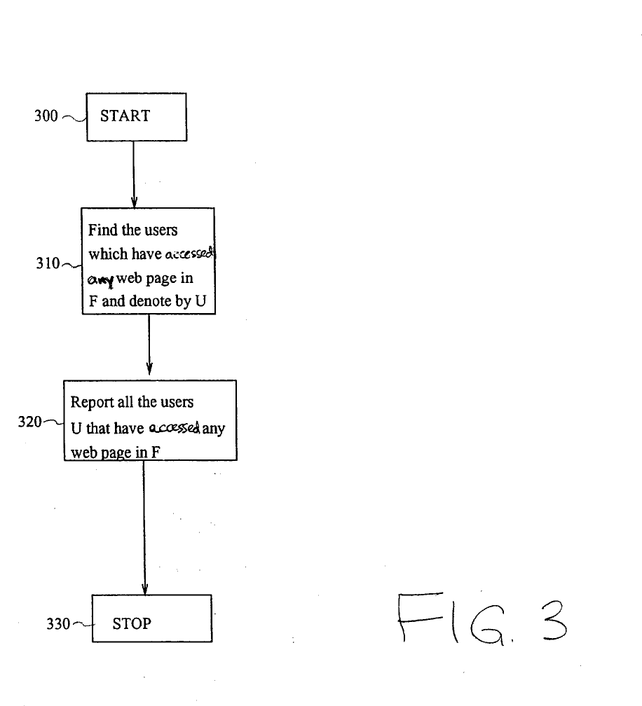

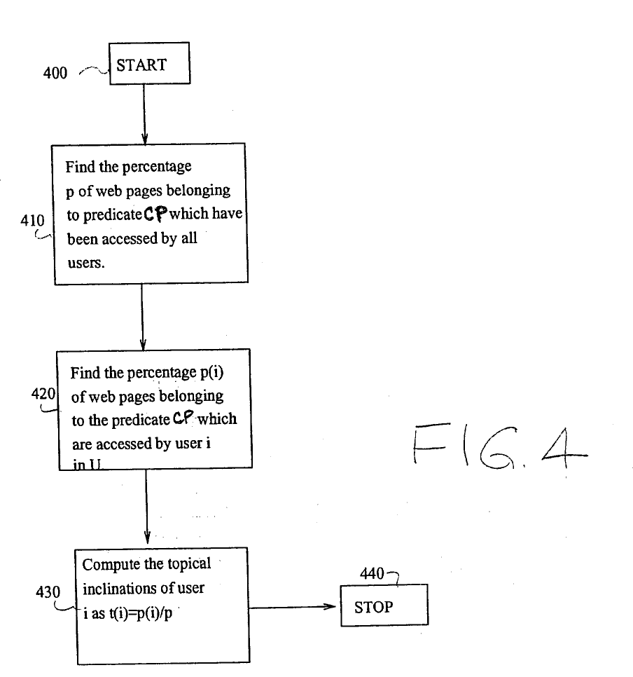

In step 230, if the candidate web page does not satisfy CP or the candidate web page does satisfy CP and is added to F, the process finds a user interest group U for the set of web pages F. A more detailed description of how this user interest group is determined is provided below in the context of FIG. 3. Next, in step 235, the process determines the topical inclination of each user in U. The topical inclination for a user indicates how much the user is interested in the web pages belonging to the predicate CP. A more detailed description of the process for determining the topical inclination of each user is provided below in the context of FIG. 4.

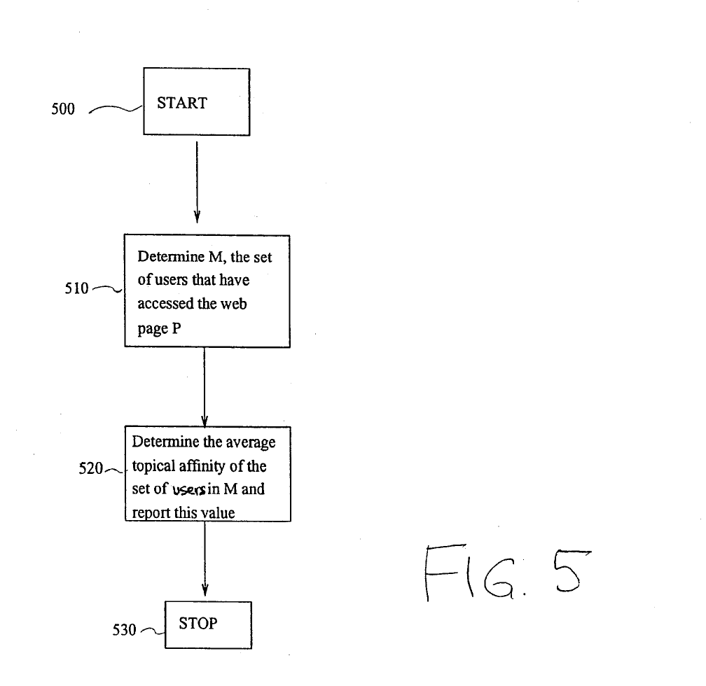

Once the topical inclination of each user has been determined, the process determines the topical affinity of each web page W accessed by user interest group U, in step 240. The topical affinity of a candidate web page is the likelihood that the candidate web page satisfies the predicate based on the access behavior of the different users. A more detailed description of the process for determining the topical affinity of a web page is provided below in the context of FIG. 5.

In step 245, the process adds those URLs to L which were never even once added to L. In step 250, C is deleted from the list L. In step 255, the process checks whether or not the list L is empty. If L is empty, then the process returns the final set of web pages crawled F, in step 260, and the process ends at block 270. Otherwise, in step 265, the process re-orders the web pages in order of their topical affinity in the list L. Then, the process returns to the step 210 and repeats. The process iterates until L is empty.

Thus, the result of the web crawling process of FIG. 2 is a set of crawled web pages which are considered to be the web pages that satisfy the resource discovery task initiated by the user. Advantageously, such a web crawling process results in obtaining web pages specific to a given topic by leveraging the nature of the interests of a plurality of users in different topics.

FIG. 3 is a flow diagram illustrating a process used to determine a user interest group from web pages which have been crawled according to an embodiment of the present invention. The process shown in FIG. 3 illustrates a preferred technique for performing step 230 in the overall user-centered web crawling process of FIG. 3. The process begins at block 300. It is assumed that the input provided to this operation includes the list F of crawled web pages and the data from the trace log (trace log 18 of FIG. 1). That is, the user interest group U is determined with the help of the web pages in F, which is the set of web pages crawled so far that also satisfy the predicate CP.

In step 310, the process determines all the users that have accessed any web page in F. This is determined by referring to the data in the trace log for each user and checking whether each user accessed any web page in F. If the set of web pages F is null, then the user interest group U is null as well. This set of users is reported in step 320. The process ends at block 330.

An alternative embodiment may be provided in which the time spent by the user on a given web page is used to determine the user interest group. Specifically, the user interest group may be defined to be those users that have spent a minimum amount of time on a given web page.

FIG. 4 is a flow diagram illustrating a process for determining a topical inclination for each user according to an embodiment of the present invention. The process shown in FIG. 4 illustrates a preferred technique for performing step 235 in the overall user-centered web crawling process of FIG. 3. The process begins at block 400. It is assumed that the input provided to this operation includes the user interest group U (as computed in FIG. 3) and the user-defined predicate CP. The topical inclination of a user is a measure of how much the user likes a given topic. The value of the topical inclination for a user is one by default, but values different from one indicate how much more or how much less the user likes a given topic. If the value of the topical inclination value is larger than one, then this indicates that the user likes the topic more than average. If the topical inclination value is less than one, then it indicates that the user likes the topic less than average.

In step 410, the process finds the percentage p of web pages belonging to predicate CP which have been accessed by all users. In step 420, the process finds the percentage p(i) of web pages belonging to the predicate CP which have been accessed by the user i in user interest group U. Once this has been done, the process computes the topical inclination t(i) of user i as p(i)/p, in step 430. This is done for each user i in user interest group U. It is to be understood that for any user that is not in U, the value of the topical inclination is zero, since that user has not accessed even one page which satisfies the predicate CP. The process ends at block 440. Again, as in the case of FIG. 3, an alternative embodiment may use the time spent by a user on a web page rather than just determining whether or not he has accessed the web page.

FIG. 5 is a flow diagram illustrating a process for calculating a topical affinity for each web page using a topical inclination for each user according to an embodiment of the present invention. The process shown in FIG. 5 illustrates a preferred technique for performing step 240 in the overall user-centered web crawling process of FIG. 3. The process begins at block 500. It is assumed that the input provided to this operation includes a web page P, data from the trace log (trace log 18 of FIG. 1), and the topical inclination values for the users (as computed in FIG. 4).

In order to find the topical affinity of a web page, the process first finds the set of users from the trace that have accessed this web page. This is done in step 510. This set is denoted by M. Once this set M has been determined, the process uses the set to find the topical relevance of the corresponding web page. More specifically, the topical relevance is determined by finding the average topical inclination of all users in M. This average value represents the topical affinity of the web page P. These operations are performed for each web page under consideration. The process ends at block 530.

Accordingly, the present invention, as illustratively described in detail above, provides techniques for user-centered search and crawling on the world wide web. Techniques are provided for identifying the nature of the web pages which are most relevant to a given predicate. The behavior of users is used to identify and determine the web pages which are most relevant to a specific crawl. Thus, advantageously, the techniques are implemented in a web crawling system which can obtain the web pages specific to a given topic by leveraging the nature of the interests of the users in different topics.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claims is:

1. A computer-based method of performing document retrieval in accordance with an information network, the method comprising the steps of:
obtaining a query comprising at least a user-defined predicate;
determining a group of one or more users for a set of one or more documents that satisfy the predicate, the user group comprising one or more users who have previously accessed at least one of the one or more documents in the set, wherein a determination of whether a user has previously accessed a document is obtained from a log that maintains data representing user document access behavior;
determining a topical inclination value for each user in the user group, the topical inclination value for each user being indicative of a level of interest the user has in the one or more documents in the set;
determining a topical affinity value for each document accessed by the user group based on the topical inclination value determined for each user, the topical affinity value for each document being indicative of the likelihood that each document satisfies the predicate based on the access behavior associated with the one or more users in the user group; and
outputting the one or more documents ranked in accordance with their respective topical affinity values.

2. The method of claim 1, wherein the log data comprises data representing user access frequency of documents previously accessed.

3. The method of claim 1, wherein the log data comprises data representing a topical distribution of documents previously accessed.

4. The method of claim 1, wherein the step of determining the topical inclination value for a user comprises utilizing a predicate satisfaction percentage of the one or more documents accessed by a user to determine a level of inclination of that user to topics associated with the one or more documents.

5. The method of claim 1, wherein the user document access behavior is obtained from traces.

6. The method of claim 1, wherein the topical inclination value for each user is defined by an access frequency of the one or more documents belonging to the predicate compared to all other documents.

7. The method of claim 1, wherein time spent by a user on a document is used to determine the topical inclination value for the user.

8. The method of claim 1, wherein the topical inclination values of users accessing a document are averaged to determine the topical affinity value of the document.

9. Apparatus for performing document retrieval in accordance with an information network, the apparatus comprising:
a memory; and
at least one processor coupled to the memory and operative to: (i) obtain a query comprising at least a user-defined predicate; (ii) determine a group of one or more users for a set of one or more documents that satisfy the predicate, the user group comprising one or more users who have previously accessed at least one of the one or more documents in the set, wherein a determination of whether a user has previously accessed a document is obtained from a log that maintains data representing user document access behavior; (iii) determine a topical inclination value for each user in the user group, the topical inclination value for each user being indicative of a level of interest the user has in the one or more documents in the set; (iv) determine a topical affinity value for each document accessed by the user group based on the topical inclination value determined for each user, the topical affinity value for each document being indicative of the likelihood that each document satisfies the predicate based on the access behavior associated with the one or more users in the user group; and (v) output the one or more documents ranked in accordance with their respective topical affinity values.

10. The apparatus of claim 9, wherein the log data comprises data representing user access frequency of documents previously accessed.

11. The apparatus of claim 9, wherein the log data comprises data representing a topical distribution of documents previously accessed.

12. The apparatus of claim 9, wherein the operation of determining the topical inclination value for a user comprises utilizing a predicate satisfaction percentage of the one or more documents accessed by a user to determine a level of inclination of that user to topics associated with the one or more documents.

13. The apparatus of claim 9, wherein the user document access behavior is obtained from traces.

14. The apparatus of claim 9, wherein the topical inclination value for each user is defined by an access frequency of the one or more documents belonging to the predicate compared to all other documents.

15. The apparatus of claim 9, wherein time spent by a user on a document is used to determine the topical inclination value for the user.

16. The apparatus of claim 9, wherein the topical inclination values of users accessing a document are averaged to determine the topical affinity value of the document.

17. An article of manufacture for performing document retrieval in accordance with an information network, comprising a machine readable medium containing one or more programs which when executed implement the steps of:
obtaining a query comprising at least a user-defined predicate;
determining a group of one or more users for a set of one or more documents that satisfy the predicate, the user group comprising one or more users who have previously accessed at least one of the one or more documents in the set, wherein a determination of whether a user has previously accessed a document is obtained from a log that maintains data representing user document access behavior;
determining a topical inclination value for each user in the user group, the topical inclination value for each user being indicative of a level of interest the user has in the one or more documents in the set;
determining a topical affinity value for each document accessed by the user group based on the topical inclination value determined for each user, the topical affinity value for each document being indicative of the likelihood that each document satisfies the predicate based on the access behavior associated with the one or more users in the user group; and
outputting the one or more documents ranked in accordance with their respective topical affinity values.

18. The article of claim 17, wherein the log data comprises data representing user access frequency of documents previously accessed.

19. The article of claim 17, wherein the log data comprises data representing a topical distribution of documents previously accessed.

20. The article of claim 17, wherein the step of determining the topical inclination value for a user comprises utilizing a predicate satisfaction percentage of the one or more documents accessed by a user to determine a level of inclination of that user to topics associated with the one or more documents.

21. The article of claim 17, wherein the user document access behavior is obtained from traces.

22. The article of claim 17, wherein the topical inclination value for each user is defined by an access frequency of the one or more documents belonging to the predicate compared to all other documents.

23. The article of claim 17, wherein time spent by a user on a document is used to determine the topical inclination value for the user.

24. The article of claim 17, wherein the topical inclination values of users accessing a document are averaged to determine the topical affinity value of the document.
